(19) United States
(12) Patent Application Publication
(10) Pub. No.: US 2009/0108814 A1
(43) Pub. Date: Apr. 30, 2009

(54) Battery Switch Sensor

(76) Inventors: Christopher Wilkins, Titirangi (NZ); Ross G. Pratt, Waiwera (NZ); Paul G. A. Beeson, Browns Bay (NZ); Justin D. Spence, Glenfield (NZ)

Correspondence Address: QUARLES & BRADY LLP, 411 E. WISCONSIN AVENUE, SUITE 2040, MILWAUKEE, WI, 53202-4497, US

(21) Appl. No.: 12/256,887

(22) Filed: Oct. 23, 2008

(30) Foreign Application Priority Data
Oct. 24, 2007 (NZ) 562756

(51) Int. Cl. H02J 7/14

(52) U.S. Cl. 320/162

(57) ABSTRACT

The invention relates to a battery switch for use in a multi-battery vehicle to selectively connect or isolate batteries from each other. It includes a detector to monitor the voltage of at least a first battery to detect consistently present transient voltages and on detection of such voltages to connect or maintain connected the battery to at least a second battery. The detector monitors the continuance of transient voltages and additionally monitors the voltage of at least the first and second battery, and isolates the batteries from each other where the voltage of either battery falls below a specified voltage despite the detection of transient voltages at the first battery. The invention also relates to a method of initiating the interconnection or disconnection of at least two batteries on a single vehicle, and to a method of detecting the existence of a charging supply on a supply line to an open battery isolating switch.

### CROSS-REFERENCE TO RELATED APPLICATION

This application claims benefit to New Zealand Patent Application No. 562756 filed Oct. 24, 2007.

### STATEMENT CONCERNING FEDERALLY SPONSORED RESEARCH OR DEVELOPMENT

Not applicable.

### FIELD OF THE INVENTION

The invention generally relates to isolating battery switches for vehicles or vessels. More particularly the invention relates to an isolating battery switch which isolates a battery near to discharge but reconnects it if it can be charged by a charging source.

### BACKGROUND OF THE INVENTION

Battery isolation switches are known and are used to isolate a battery from the circuitry of a vehicle or vessel both to prevent the battery from discharging into unanticipated loads and to protect the capacity of at least one battery in a system of multiple batteries. Known systems normally use mechanical isolation switches but the use of electronically triggered switches is known. Such switches may isolate the battery when the battery voltage is reduced to a specified level as a result of unanticipated steady discharges but may reconnect the battery to allow further use of the vehicle or vessel if required. Such reconnection may be as the result of an action by a user, such as pressing a “Reconnect” switch or attempting to operate some other appliance on the vehicle or vessel.

Such systems do not automatically reconnect a battery of a multiple battery system where the battery has been disconnected because of a low voltage condition unless a DC charging voltage close to the upper charging voltage for a battery is detected on a supply line. In some conditions, for instance where the “on line” battery is faulty, the disconnected battery will never be reconnected because the DC voltage will not rise high enough.

Therefore a need exists for a solution to the problem of maintaining a connection between the batteries or re-connecting a battery, which is not absolutely dependent on the battery(s) voltage(s).

A further variation is shown by NZ patent 229179 which provides for connecting both batteries when starting but disconnecting one of them when no vibration or noise has been present for a time in.

U.S. Pat. No. 5,903,063 provides a similar method of controlling the load on a battery by detecting band filtered artifacts of the ignition noise on the supply line.

U.S. Pat. No. 5,459,357 provides for controlling the load on a battery in dependence on the detection of the alternator operation, for instance by detecting the alternator frequency on the supply line. U.S. Pat. No. 5,225,761 switches an auxiliary battery into circuit when an AC voltage is detected on the alternator supply line.

These methods do not provide a fail safe option which will best manage multiple batteries so that a boat owner is almost certain to have sufficient charge in a battery to start the engine.

The present invention provides a solution to this and other problems which offers advantages over the prior art or which will at least provide the public with a useful choice.

### SUMMARY OF THE INVENTION

In one exemplification the invention consists in a battery switch for use in a multi-battery vehicle to selectively connect or isolate batteries from each other and including a detector monitoring the voltage of at least a first battery to detect consistently present transient voltages and on detection of such voltages to connect or maintain connected the at least one battery to at least a second battery, the detector monitoring the continuance of transient voltages and additionally monitoring the voltage of at least the first battery and at least the second battery, and isolating the batteries from each other where the voltage of either battery falls below a specified voltage despite the detection of transient voltages at the first battery.

Preferably a battery charging supply providing consistently present transient voltages is connected to at least one battery.

Preferably battery charging supplies providing consistently present transient voltages are separately connected to the first and the second battery.

Preferably battery charging supplies providing repetitive transient voltages are separately connected to the first and the second battery and one of the battery charging supplies is provided from a vehicle source while the other is from a remotely powered source.

Alternatively the invention may be said to relate to a method of initiating the interconnection or disconnection of at least two batteries on a single vehicle by monitoring the voltage of each battery, monitoring the existence of consistently present transient voltages at each battery and connecting batteries to each other when transient voltages are present on at least one battery and the batteries are both above a specified voltage, disconnecting the batteries from each other if the voltage falls below a second lesser specified voltage regardless of the presence or absence of transient voltages.

Preferably the transient voltages are the fuel injector solenoid pulses of an alternator driving engine.

Preferably the transient voltages include at least slip ring hash from an alternator driving engine.

Preferably the transient voltages include at least ignition noise from an alternator driving engine.

Preferably the transient voltages are mains borne transients in a mains battery charger.

Preferably the transient voltages are detected by an AC amplifier in combination with a band pass filter.

Preferably the band pass filter accepts components from 20 Hz to 40 KHz.

In a further embodiment the invention may be said to relate to a method of detecting the existence of a charging supply on a supply line to an open battery isolating switch by:

measuring artifacts on the supply line,

detecting transient artifacts consistent with the existence of a charging supply on the supply line,

activating a switch closure device if the supply line is above a specified voltage and,

opening a closed battery isolating switch if the supply line voltage decreases below a second lesser specified voltage regardless of the presence of transient artifacts on the supply line.

These and other features of as well as advantages which characterize the present invention will be apparent upon reading of the following detailed description and review of the associated drawings.

### BRIEF DESCRIPTION OF THE DRAWINGS

FIG. 1 is a general circuit diagram of the inventive system.

FIG. 2 is a flow diagram of the detection of a transient voltage.

### DETAILED DESCRIPTION OF THE PREFERRED EMBODIMENT

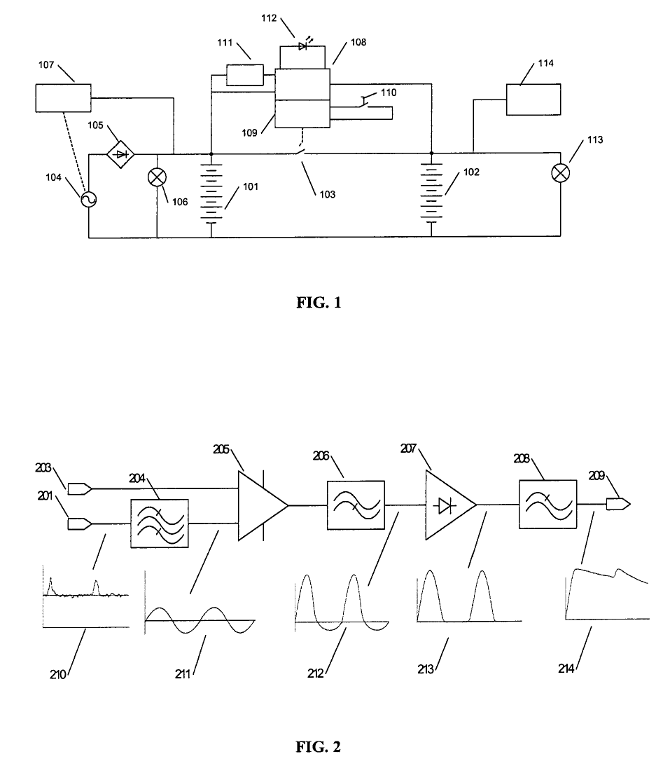

Referring now to FIG. 1 a descriptive circuit diagram is shown in which two batteries 101, 102, are typically on board a vessel with battery 101 dedicated to engine functions such as engine starting, engine space ventilation, bilge pumps, etc. represented by load 106 for engine 107 and battery 102 dedicated to house functions such as refrigerator, riding lights, navigation instruments, etc. represented by load 113.

The batteries may be connected by a switch 103 so that either can assist the other or so that both may be charged together. The charging functions are provided by either or both of alternator 104 with bridge rectifier 105 or by a mains powered charger 114 or other remotely powered source connected when the vessel is docked.

Switch 103 may be an electronic switch, typically a high current FET (Field Effect Transistor); or a mechanical switch of known type operated by a motor, solenoid or relay. The switch is operated by a microprocessor 109 either as the result of pressing manual switch 110, or as the result of the detection by engine operation detection circuitry 108 of a charging state on either side of the switch supply in conjunction with electrical noise detector 111. An indicator LED 112 may operate to show the current state of the switch and a warning of the degree of charge of the batteries when this is critical.

Manual switch 110 operates a program in microprocessor 109 which closes the switch for a time such as 10 minutes regardless of the charge state of either battery. Typically this action may be taken when the engine battery 101 is almost flat, the engine still has not started and the house battery 102 still has a high state of charge. Alternatively, if the engine battery 101 is high and the house battery 102 is low, the switch 110 can be operated to use the engine battery power to help power the house load 113.

Normally the two batteries are connected or disconnected depending on the operational state detected by the engine state detection circuitry 108 in conjunction with the noise detector 111.

This detects the presence of repetitive transient voltages on the engine battery terminals. Typically when an engine alternator 104 is charging a battery there will be some alternator ripple from the operation of the alternator, and this may be detected as an indicator of alternator charging, however when a battery is near its nominal charged voltage the ripple declines to zero, and it is difficult to determine whether an engine charging state exists from this ripple voltage. The present invention has found that the engine itself generates transient voltages on the battery supply line which can be detected and used as an indication that the engine is running, and therefore charging the battery. Such transients include (but are not limited to), on a petrol engine, ignition noise, on a diesel engine injector solenoid pulses and on both petrol and diesel engines, alternator slip ring hash.

The pulse width of these transients is much narrower than that of alternator ripple and the battery does not so easily act as a sink for these currents, which means that they can be detected relatively easily. In similar fashion the mains power supply 114 for the house battery passes on a level of transients from the mains supply due to switching and surge effects in the mains as a whole which act as an indication that charging of the house battery is taking place.

It is therefore possible to construct a state table indicating when the switch should be closed depending on the current charge state. This is shown as Table 1 below. The table is predicated on the basis that the engine alternator has the capability to charge both batteries while maintaining the charge voltage above 13.7 volts while the mains charger cannot maintain such a voltage except when the batteries are close to charged.

TABLE 1

| # | INPUT | OUTPUT | RIPPLE | LED | CONTACTS |
|---|---|---|---|---|---|
| 1 | >13.7 | >13.7 | N/A | TURN ON | CLOSE |
| 2 | >13.7 | <13.0 | N/A | TURN ON | CLOSE |
| 3 | <13.0 | >13.7 | N/A | TURN ON | CLOSE |
| 4 | <13.0 | <13.0 | TRUE | NO CHANGE | NO CHANGE |
| 5 | <13.0 | <13.0 | FALSE | TURN OFF | OPEN |
| 6 | <12.2 | <12.2 | TRUE | LV FLASH THEN | OPEN |
| | | | | TURN OFF | |
| 7 | <12.2 | <12.2 | FALSE | TURN OFF | OPEN |

The table shows the inputs to the microprocessor and consist of the voltage from the boat battery 101 (INPUT), the voltage from the house battery 102 (OUTPUT), whether a ripple is currently being detected on the input line from detector 111 (RIPPLE), the action relating to the state of the indicator LED 112 (LED) and the action relating to the contacts 103 (CONTACTS).

In state 1 both the house and boat batteries are above the nominal voltage for more than 5 seconds and it is unimportant whether a voltage ripple is detected. The safe assumption can be made that both batteries are at least 50% charged. The switch 103 can be safely closed to provide maximum battery capacity and LED 112 will be switched on to show the switch is closed and the voltages are above the nominal level.

In state 2 the boat battery is above nominal voltage, the house battery is below nominal voltage and possibly near flat and it is not necessary to determine whether the engine is charging. The system will connect the house battery in by closing the contacts of switch 103 but will turn the LED indicator 112 on to show the switch is closed.

In state 3 the boat battery is below nominal voltage and possibly flat while the house battery is satisfactory and possibly under charge by the mains charger 114, although it is unnecessary to determine whether this is so. The system will connect the two batteries with switch 103 after 5 minutes if the situation is still stable and will again ensure the LED is on to show that the switch is closed.

In state 4 both batteries are below the nominal voltage but the engine is producing transients which have been detected at a level sufficient to show ripple output as True. The engine is probably charging the batteries and hence the switch may be left in its existing condition. If open and being charged the voltage will eventually rise if everything is in order placing the system in state 1, otherwise the voltage will eventually fall and the options for one of the other states will occur.

State 5 shows both batteries as being below nominal voltage with no detected ripple, indicating that the engine is not running, or is not charging. In such circumstances it is better to isolate the two batteries in order to save what charge remains, and so switch 103 will be opened and the LED 112 will also be turned off.

In state 6 both batteries are below a safe voltage and although the ripple detector has detected that the engine is running either it is not charging or the load is so large that the voltage is sagging. If the voltage remains in this state for five seconds LED 112 will flash to indicate low voltage. If the system remains in this state for more than 5 minutes the system will open switch 103 to isolate the house battery and LED 112 will be turned off.

Finally in state 7 both batteries are below a safe voltage and the system can detect no sign of charging. If the system remains in this state for more than a few seconds switch 103 will be opened and LED 112 will be set to flash to indicate a low voltage.

While seven states have been defined above the system may be configured to respond to more or less than the indicated seven states. The voltages given are indicative only and will vary depending on the system operating voltage, battery type, etc.

In general the table indicates that the engine battery is charged whenever possible, and that where transient voltages are detected on the engine side but the battery voltage is not such as to indicate a charging state exists a warning will be provided. Such a warning may be an indication light on the control panel or an audio warning. At the same time the control system attempts to maintain a charge in the engine battery from the house battery if possible.

Detection of transient repetitive voltages is provided by noise detector 111 which, as shown in FIG. 2 consists of an input at 201 from the voltage supply line in a vessel or vehicle and a stable bias voltage at 203. Input 201 contains a waveform such as that at 210 which typically consists of random hash plus transients produced by the ignition pulses on a petrol engine or the electrical solenoid pulses on a modern diesel engine. These pulses repeat regularly at a frequency related to the number of cylinders in the engine and the revolutions per minute (RPM) of the engine. A band pass filter 204 selects the frequency band covered the repetition rate of the pulses within the RPM range of the engine. Typically this results in a required frequency range from 20 Hz to 1000 Hz but may be extended to 30 KHZ to account for variations such as twin two stroke multi-cylinder outboards which will produce interfering pulse trains.

The filtered transients and the bias voltage 205 are applied to an amplifier 205 which produces an amplified clipped waveform which is passed through a high pass filter 206 which trims out any high frequency transients remaining to produce a waveform approaching that at 212. This waveform is passed via precision rectifier and amplifier 207 to provide the positive going waveform at 213. This is passed via a low pass filter 208 to substantially remove AC components to provide near DC voltage 214 which indicates the presence of the original transient pulses and produces the indicator voltage at output 209 to be supplied to microprocessor 109 of FIG. 1.

While the above description shows the invention in operation for repetitive transient voltages the same circuit provides the required DC output voltage from any combination of short term transient voltages provided that the pulse length falls within the bandpass filter 204. This commonly includes slip ring hash, spark ignition noise, injector solenoid pulses and mains borne switching transients such as phase control artifacts. While these may be repetitive they are not required to be so by the invention so long as whatever combination of transient voltages present has a sufficient component falling within the pass band of filter 204.

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example the particular elements of the voltage detection circuitry and noise detector may vary dependent on the particular application for which it is used without variation in the spirit and scope of the present invention.

In addition, although the preferred embodiments described herein are directed to battery switches for use in a battery system on a vehicle or vessel, it will be appreciated by those skilled in the art that the teachings of the present invention can be applied to other systems such as telephone exchange supplies, without departing from the scope and spirit of the present invention.

We claim:

1. A battery switch for use in a multi-battery vehicle to selectively connect or isolate batteries from each other and including a detector monitoring the voltage of at least a first battery to detect consistently present transient voltages and on detection of such voltages to connect or maintain connected the at least one battery to at least a second battery, the detector monitoring the continuance of transient voltages and additionally monitoring the voltage of at least the first battery and at least the second battery, and isolating the batteries from each other where the voltage of either battery falls below a specified voltage despite the detection of transient voltages at the first battery.

2. A battery switch as claimed in claim 1 wherein a battery charging supply providing consistently present transient voltages is connected to at least one battery.

3. A battery switch as claimed in claim 1 wherein battery charging supplies providing consistently present transient voltages are separately connected to the first and the second battery.

4. A battery switch as claimed in claim 1 wherein battery charging supplies providing repetitive transient voltages are separately connected to the first and the second battery and one of the battery charging supplies is provided from a vehicle source while the other is from a remotely powered source.

5. A battery switch as claimed in claim 1 wherein the transient voltages are detected by an AC amplifier in combination with a band pass filter.

6 A battery switch as claimed in claim 5 wherein the band pass filter accepts components from 20 Hz to 40 KHz

7. A method of initiating the interconnection or disconnection of at least two batteries on a single vehicle by monitoring the voltage of each battery, monitoring the existence of consistently present transient voltages at each battery and connecting batteries to each other when transient voltages are present on at least one battery and the batteries are both above a specified voltage, disconnecting the batteries from each other if the voltage falls below a second lesser specified voltage regardless of the presence or absence of transient voltages.

8. A method of initiating the interconnection or disconnection of at least two batteries on a single vehicle as claimed in claim 7 wherein the transient voltages are the fuel injector solenoid pulses of an alternator driving engine.

9. A method of initiating the interconnection or disconnection of at least two batteries on a single vehicle as claimed in claim 7 wherein the transient voltages include at least slip ring hash from an alternator driving engine.

10. A method of initiating the interconnection or disconnection of at least two batteries on a single vehicle as claimed in claim 7 wherein the transient voltages include at least ignition noise from an alternator driving engine.

11. A method of initiating the interconnection or disconnection of at least two batteries on a single vehicle as claimed in claim 7 wherein the transient voltages are mains borne transients in a mains battery charger.

12. A method of detecting the existence of a charging supply on a supply line to an open battery isolating switch by:
measuring artifacts on the supply line,
detecting transient artifacts consistent with the existence of a charging supply on the supply line,
activating a switch closure device if the supply line is above a specified voltage and,
opening a closed battery isolating switch if the supply line voltage decreases below a second lesser specified voltage regardless of the presence of transient artifacts on the supply line.
